(19) United States
(12) Patent Application Publication
(10) Pub. No.: US 2007/0194112 A1
(43) Pub. Date: Aug. 23, 2007

(54) Security summary for retail receipt

(76) Inventor: Steven M. Petroskey, Durham, NC (US)

Correspondence Address: DILLON & YUDELL LLP, 8911 N. CAPITAL OF TEXAS HWY.,, SUITE 2110, AUSTIN, TX, 78759, US

(21) Appl. No.: 11/360,335

(22) Filed: Feb. 23, 2006

(51) Int. Cl. G06K 15/00; G06Q 20/00

(52) U.S. Cl. 235/383; 705/16

(57) ABSTRACT

A method, apparatus and computer-readable medium for determining if a retail purchase is proper is presented. In one embodiment, the method includes the steps of creating a list of items that require purchase review when being purchased at a checkout station in a store; scanning one or more items for purchase at the checkout station; and creating a listing of the scanned items that match the list of items that require purchase review, wherein the listing contains headings of review types for reviews that are required for the scanned items that match the list of items that require purchase review.

### BACKGROUND OF THE INVENTION

1. Technical Field

The present invention relates in general to the field of computers and similar technology systems, and in particular to software utilized by such systems to implement methods and processes. Still more particularly, the present invention relates to the field of retail checkout procedures.

2. Description of the Related Art

Retailers using self-checkout kiosks, or retailers in retail warehouse environments, require a store employee to quickly audit a shopper's order against the customer's sales receipt to verify that the shopper meets any requirements to purchase all of the items, that all items in an order have been paid for, and that the shopper did not exceed authorized limits of a quantity of particular items selected. For example, alcoholic beverages may only be purchased by a shopper who is over 21 years of age, certain items may need to be carefully examined due to their being prone to shrinkage (theft) due to their easily concealable nature, high price, etc., and other items may be available for purchase only in limited quantities, either due to legal requirements or sales conditions of the store, etc. Typically, the customer's receipt does not highlight items that require such additional attention by the store's employees, thus making it difficult for a checker (or a monitor person where self-checkout devices are used) to confirm that the buyer is in fact authorized to purchase the product(s), and that all products are proper in quantity and have been paid for.

### SUMMARY OF THE INVENTION

To address the problem described above, an improved method, apparatus and computer-readable medium for determining if a retail purchase is proper is presented. In one embodiment, the method includes the steps of creating a list of items that require purchase review when being purchased at a checkout station in a store; scanning one or more items for purchase at the checkout station; and creating a listing of the scanned items that match the list of items that require purchase review, wherein the listing contains headings of review types for reviews that are required for the scanned items that match the list of items that require purchase review.

The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1a illustrates an exemplary computer system in which the present invention may be implemented for scanning and evaluating purchased products in a retail environment;

FIG. 1b depicts additional detail of a content of memory in the computer system illustrated in FIG. 1a;

FIG. 2 is a flow-chart showing exemplary steps taken to ensure that scanned products are complete and proper for purchase by a particular class of buyer; and

FIG. 3 depicts an exemplary customer receipt with a listing, complete with heading types, of products that require a post-purchase review.

### DETAILED DESCRIPTION OF THE PREFERRED EMBODIMENT

The present invention presents a solution to security and purchase review through the use of a security (authorization) summary that is placed on a customer's receipt at checkout time. This summary is in an additional area or ordered section of the customer receipt, and contains all items identified by store business rules as requiring verification during an audit of a customer order. Categories of items to be placed in the summary section include, but are not limited to, age restricted items (minimum age requirement to purchase items such as alcohol, tobacco, certain magazines, books, videos, etc.), bulky items, and low weight items. Placing all items that need to be verified into a consolidated section of the receipt allows a store employee to quickly identify all high priority items, particularly in orders with a large number of items. This quickens the audit process for the shopper as well as increases order security.

To implement the present invention, a subroutine is added to a self-checkout (or, in an alternate embodiment, a manned checkout) system. On a system level, a list of items requiring cashier validation is maintained either in a manned Point Of Sale (POS) checkout system or as part of a self-checkout system. In addition, security logic in the self-checkout system identifies questionable scenarios that should be verified by the cashier before the shopper is allowed to complete a transaction or leave the store. Such questionable transactions include, but are not limited to, purchasing an unusually large or small quantity of a particular item; purchasing, as part of a very large order, one or two items that historically are prone to being shoplifted (stolen) by customers; purchasing items at an unusual time of day (e.g., buying a large quantity of alcoholic beverages late at night or early in the morning), etc. As the customer's order proceeds, the system maintains a list of items that meet these conditions, along with a description of the category for the cashier (e.g., “Age restriction—verify shopper is 21”). At the time of receipt printing, this information is summarized and inserted into the printer stream to be part of the receipt.

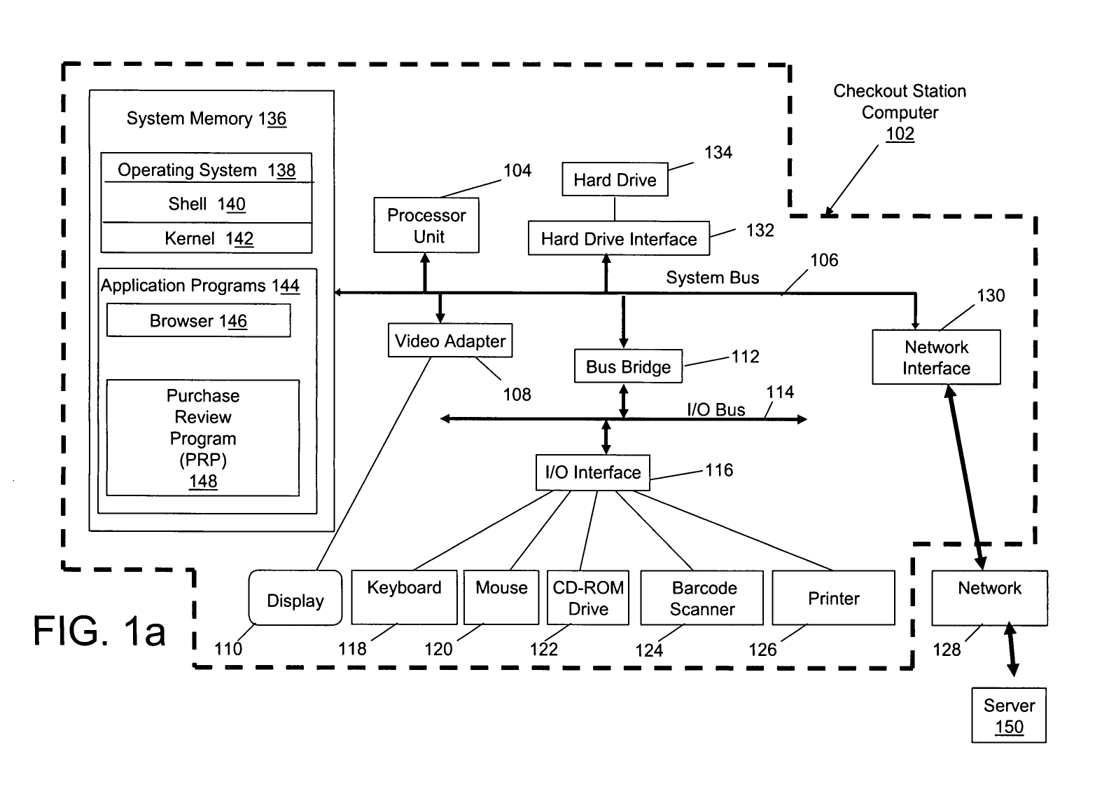

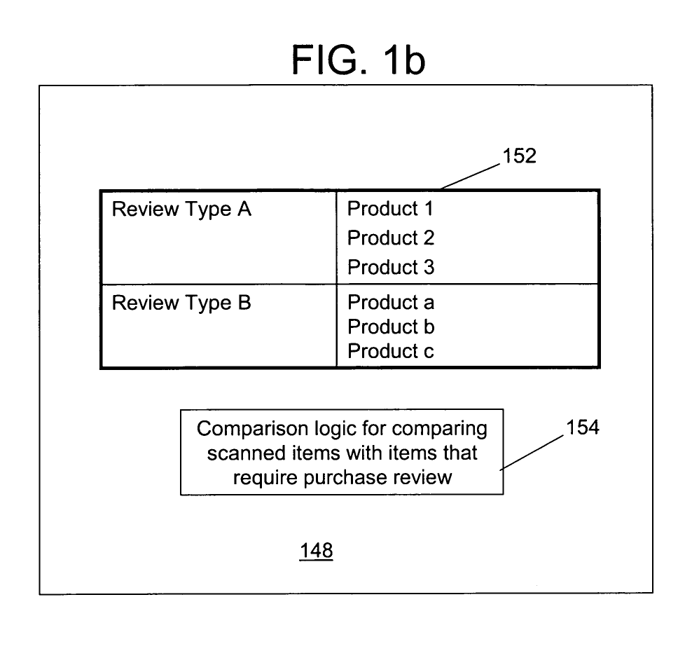

With reference now to the figures, and in particular to FIG. 1, there is depicted a block diagram of an exemplary checkout station computer 102 in which the present invention may be utilized in a store at either a manned checkout station or at a self-checkout device (e.g., kiosk). Checkout station computer 102 includes a processor unit 104 that is coupled to a system bus 106. A video adapter 108, which drives/supports a display 110, is also coupled to system bus 106. System bus 106 is coupled via a bus bridge 112 to an Input/Output (I/O) bus 114. An I/O interface 116 is coupled to I/O bus 114. I/O interface 116 affords communication with various I/O devices, including a keyboard 118, a mouse 120, a Compact Disk—Read Only Memory (CD-ROM) drive 122, a barcode (laser) scanner 124 (for scanning bar codes off products being purchased), and a printer 126 (for printing a customer receipt). The format of the ports connected to I/O interface 116 may be any known to those skilled in the art of computer architecture, including but not limited to Universal Serial Bus (USB) ports.

Checkout station computer 102 is able to communicate with a server 150 via a network 128 using a network interface 130, which is coupled to system bus 106. Network 128 may be an external network such as the Internet, or an internal network such as an Ethernet or a Virtual Private Network (VPN). Server 150 may have a similar architecture as described for checkout station computer 102.

A hard drive interface 132 is also coupled to system bus 106. Hard drive interface 132 interfaces with a hard drive 134. In a preferred embodiment, hard drive 134 populates a system memory 136, which is also coupled to system bus 106. Data that populates system memory 136 includes checkout station computer 102's operating system (OS) 138 and application programs 144.

OS 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present invention will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management.

Application programs 144 include a browser 146. Browser 146 includes program modules and instructions enabling a World Wide Web (WWW) client (i.e., checkout station computer 102) to send and receive network messages to the Internet using HyperText Transfer Protocol (HTTP) messaging, thus enabling communication with server 150. Note that communication between checkout station computer 102 and server 150 may alternatively be via messages using extensible Markup Language (XML)/ Simple Object Access Protocol (SOAP), Remote Procedure Call (RPC), Remote Method Invocation (RMI), Transmission Control Protocol/Internet Protocol (TCP/IP), or any other standard or proprietary communication protocol.

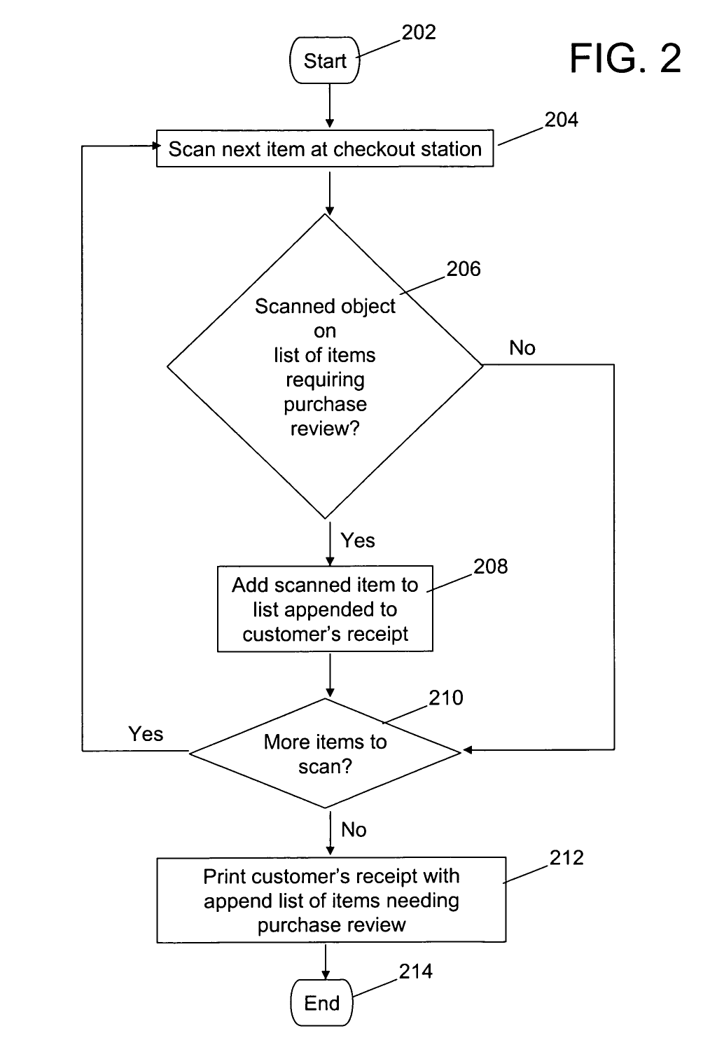

Application programs 144 in checkout station computer 102's system memory also include a Purchase Review Program (PRP) 148. PRP 148 includes code for implementing the processes described in FIG. 2, and includes the data structure represented in exemplary fashion in FIG. 1b. In one embodiment, checkout station computer 102 is able to download PRP 148 from server 150. Alternatively, server 150 may perform many or all of the execution of processes found in PRP 148, thus freeing up resources in checkout station computer 102.

The hardware elements depicted in checkout station computer 102 are not intended to be exhaustive, but rather are representative to highlight essential components required by the present invention. For instance, checkout station computer 102 may include alternate memory storage devices such as magnetic cassettes, Digital Versatile Disks (DVDs), Bernoulli cartridges, and the like. These and other variations are intended to be within the spirit and scope of the present invention.

Referring now to FIG. 1b, additional detail of the contents of PRP 148 are presented. PRP 148 includes a list 152 of items that require purchase review at a checkout station. List 152 is in table form, and includes both review types as well as listing of products under each review type. For example, “Review Type A” may be for alcoholic beverages, which require the customer to be 21 in order to be authorized to purchase the item. Associated with “Review Type A” are all alcoholic beverages sold by the store, or alternatively, those alcoholic beverages (Products 1, 2 and 3) known to be favored by minors. Thus, items such as expensive sparkling wines may not be associated with “Review Type A,” but inexpensive beer or wine would be. Similarly, associated with “Review Type B” may be products (Products a, b and c) that are known to be subject to theft, due to their easily concealed size, their high cost, etc. Thus, whenever one of these items is scanned, it will appear on the summary of flagged items at the end of the customer's receipt.

Also included in (or accessible to) PRP 148 is logic 154, which is able to compare scanned items (at the POS station or the self-checkout station) with items found in list 152. If a match is found, then the matching scanned item is added to a summary that is printed at the end of the customer's receipt. Referring now to FIG. 2, a flow-chart of exemplary steps taken by the present invention is presented. After initiator block 202, an item is scanned (the bar code on the packaging is read) at a checkout station (block 204), which may be either a staffed POS station or a self-checkout station. As described by query block 206, if the scanned item is found in list 152 (shown in FIG. 1b), then that scanned item is added to the list of items that will be appended to the end of the customer's receipt, indicating that the item requires purchase review (block 208). This purchase review may involve checking the age of the customer, confirming that the number of items scanned comports with the number of items in the customer's shopping bag, determining if the customer has the right (legal or store based) to purchase the item, etc. If there are no more items to be scanned (query block 210), then the customer's receipt is printed (assuming payment has been made), as described in block 212. This listing is categorized under different categories (“Review Type” shown in file 152). These categories are likewise printed as headings to each of the purchased items that fall under that category. Note that the described printout on the customer's receipt may also (or alternatively) be printed on a separate report at an attendant station or at the store exit. Thus, a store employee can check over only items that are deemed worthy of scrutiny by the store, without the shopper being alerted as to which items will be examined/inspected for approval.

Note that in another embodiment, the separate report (or the customer's receipt) is assigned a transaction number (preferably printed as a computer-readable bar code), which serves several purposes. First, this transaction number can be used to retrieve the report (or receipt) so that is can be transmitted to a device such as a wireless Personal Digital Assistant (PDA) hand scanner, which is used by a store employee at the store exit when reviewing the high-priority contents of the customer's shopping cart. In one embodiment, this process takes the steps of assigning a transaction number to the scanned items that match the list of items that require purchase review; printing the transaction number on a customer's receipt; retrieving a listing of the scanned items by querying a table that associates the transaction number with the scanned items; and transmitting the transaction number and the scanned items to a wireless handheld device, wherein an employee confirms that the scanned items in a customer's shopping cart conform to a required purchase review, and wherein the specific customer's shopping cart is identified by correlating the transaction number that is received at the wireless handheld device with the transaction number that is printed on the customer's receipt.

Second, this transaction number can be used as an additional audit trail for the store, since the event of retrieving and reviewing the order can also be logged indicating which employee visually verified the order associated with the transaction number. The process then ends at terminator block 214.

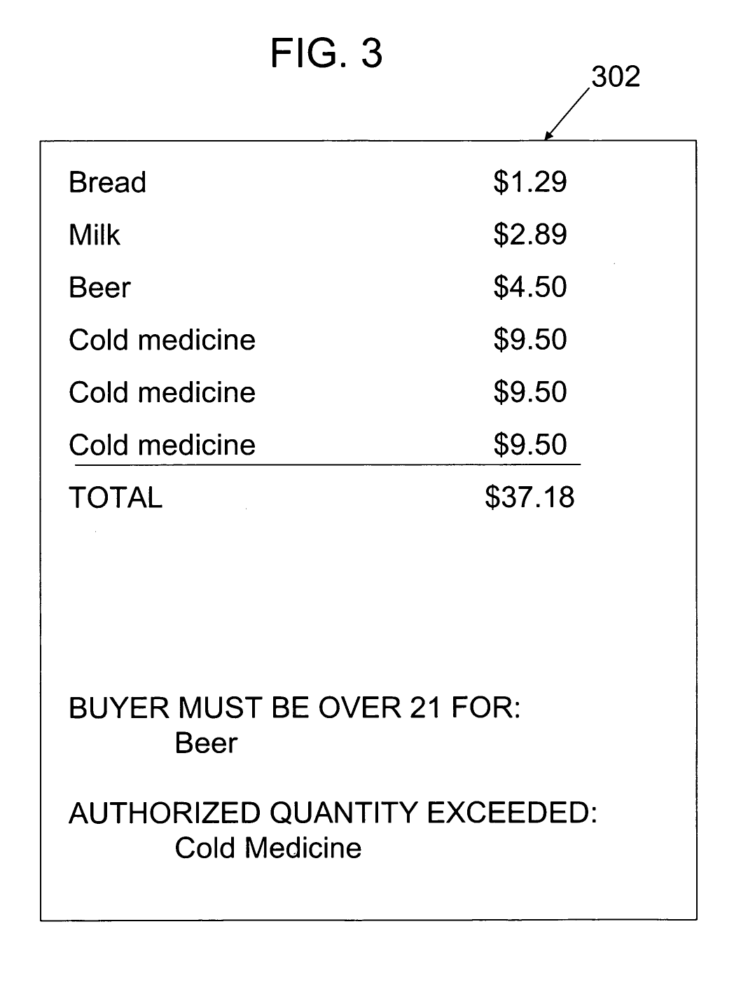

Referring now to FIG. 3, an exemplary customer receipt 302 is presented. Note that at the end of customer receipt 302 is a listing, complete with headings, or items that require additional review by a store employee. For example, PRP 148 has detected that a brand of beer that is popular with underage drinkers has been scanned (and paid for if at a self-checkout kiosk). This detection results in the message at the end of customer receipt 302, stating that for “Beer,” the “BUYER MUST BE OVER 21.” Furthermore, WHILE three packages of cold medicine have been scanned, federal law may prohibit the purchase of more than two packages of this type of cold medicine. Note that in one embodiment, PRP 148 will detect different brands of cold medicine that have the same regulated ingredient, such as ephedrine or pseudoephedrine. Thus, the purchase of either the same or different products with the same regulated ingredient will trigger the alert “AUTHORIZED QUANTITY EXCEEDED,” as depicted at the bottom of customer receipt 302. The summarized listing of scanned items that match the list of items (e.g., list 152 shown in FIG. 1b) that require a purchase review are shown in a list at the end of the customer receipt 302 under different headings that describe different review issues. This summary with headings makes the job of the store reviewer easier, since the store review can review all items of a same type which may require a same document. That is, by knowing that the buyer must be over 21 to purchase certain items, then the reviewer can hold onto the buyer's state issued identification card (ID) showing proof of age while check all such items (beer, tobacco, certain publications, etc.) After these items are reviewed, then the reviewer can return the ID to the shopper, and address the next review matter.

The present invention thus provides a novel method and system for controlling purchases at both manned POS stations as well as self-service stations. The method includes the steps of creating a list of items that require purchase review when being purchased at a checkout station in a store, scanning one or more items for purchase at the checkout station; creating a listing of the scanned items that match the list of items that require purchase review, wherein the listing contains headings of review types for reviews that are required for the scanned items that match the list of items that require purchase review, and appending, to an end of a customer's receipt, the listing of scanned items that match the list of items that require purchase review. The review type may be based on a minimum age requirement of a buyer to purchase an adult product, which is required if the adult product is an alcoholic beverage, a tobacco product, an adult magazine, video game, movie, etc. Similarly, the review type may be based on a maximum quantity of items permitted to be purchased in a single transaction. The maximum quantity of items may be based on a legal requirement. For example, there may be a law that limits the amount of cold medicine that may be purchased, since certain such products are easily converted into an illegal drug such as methamphetamine. Alternatively, the maximum quantity of items may be based on a condition of sale set by the store (such as limiting two reduce-priced sale items to a customer).

As stated, the checkout station may be manned or it may be a self-checkout device. In the case of a self-checkout device, it is especially useful to define a review type that is based on a particular product that is easily concealable, particularly such products that have a high price tag or have a history of being stolen from the store. With such a review type, then upon generation of the customer receipt with the flagged items categorized at the end of the receipt, this receipt can be used at an exit door of the store by a checker store employee, who can use the modified receipt to manually check only scanned items that match the history of the product being stolen from the store. Similarly, items printed at the bottom of the receipt may be only those items that exceed a minimum price, such that the security checker need only be concerned with “big ticket” items.

While the present invention has been particularly shown and described with reference to a preferred embodiment, it will be understood by those skilled in the art that various changes in form and detail may be made therein without departing from the spirit and scope of the invention. Furthermore, as used in the specification and the appended claims, the term “computer” or “system” or “computer system” or “computing device” includes any data processing system including, but not limited to, personal computers, servers, workstations, network computers, main frame computers, routers, switches, Personal Digital Assistants (PDA's), telephones, and any other system capable of processing, transmitting, receiving, capturing and/or storing data.

What is claimed is:

1. A method comprising:
creating a list of items that require purchase review when being purchased at a checkout station in a store;
scanning one or more items for purchase at the checkout station; and
creating a listing of the scanned items that match the list of items that require purchase review, wherein the listing contains headings of review types for reviews that are required for the scanned items that match the list of items that require purchase review.

2. The method of claim 1, further comprising:
appending, to an end of a customer's receipt, the listing of scanned items that match the list of items that require purchase review.

3. The method of claim 1, wherein the review type is based on a minimum age requirement of a buyer to purchase an adult product.

4. The method of claim 3, wherein the adult product is an alcoholic beverage.

5. The method of claim 3, wherein the adult product is a tobacco product.

6. The method of claim 1, wherein the review type is based on a maximum quantity of items permitted to be purchased in a single transaction.

7. The method of claim 6, wherein the maximum quantity of items is based on a legal requirement.

8. The method of claim 6, wherein the maximum quantity of items is based on a condition of sale set by the store.

9. The method of claim 1, further comprising:
assigning a transaction number to the scanned items that match the list of items that require purchase review;
printing the transaction number on a customer's receipt;
retrieving a listing of the scanned items by querying a table that associates the transaction number with the scanned items; and
transmitting the transaction number and the scanned items to a wireless handheld device, wherein an employee confirms that the scanned items in a customer's shopping cart conform to a required purchase review, and wherein the specific customer's shopping cart is identified by correlating the transaction number that is received at the wireless handheld device with the transaction number that is printed on the customer's receipt.

10. The method of claim 9, wherein the checkout station is a self-checkout device, and wherein a review type for a particular product is based on that particular product being easily concealable.

11. The method of claim 9, wherein a review type for a particular product is based on a history of that particular product being stolen from the store.

12. The method of claim 1, further comprising:
printing, at a printer located at an attendant station, a listing of only the scanned items that match the list of items that require purchase review, wherein a shopper is unaware of which items will be scrutinized by an employee of the store.

13. The method of claim 1, wherein the review type is based on a minimum price of a product, and wherein only scanned products that exceed the minimum price are listed at an end of a customer's receipt.

14. A system comprising:
a processor;
a data bus coupled to the processor;
a memory coupled to the data bus; and
a computer-usable medium embodying computer program code, the computer program code comprising instructions executable by the processor and configured for:
creating a list of items that require purchase review at a checkout station in a store;
scanning one or more items for purchase at the checkout station; and
creating a listing of the scanned items that match the list of items that require purchase review, wherein the listing contains headings of review types for reviews that are required for the scanned items that match the list of items that require purchase review.

15. The system of claim 14, wherein the instructions are further configured for:
appending, to an end of a customer's receipt, the listing of scanned items that match the list of items that require purchase review.

16. The system of claim 14, wherein the checkout station is a self-checkout device.

17. A computer-usable medium embodying computer program code, the computer program code comprising computer executable instructions configured for:
creating a list of items that require purchase review at a checkout station in a store;
scanning one or more items for purchase at the checkout station; and
creating a listing of the scanned items that match the list of items that require purchase review, wherein the listing contains headings of review types for reviews that are required for the scanned items that match the list of items that require purchase review.

18. The computer-usable medium of claim 17, wherein the computer executable instructions are further configured for:
appending, to an end of a customer's receipt, the listing of scanned items that match the list of items that require purchase review.

19. The computer-usable medium of claim 17, wherein the checkout station is a self-checkout device.

20. The computer-usable medium of claim 17, wherein the review type is based on a minimum price of a product, and wherein only scanned products that exceed the minimum price are listed at an end of a customer's receipt.
